(19) United States
(12) Patent Application Publication
(10) Pub. No.: US 2026/0301416 A1
(43) Pub. Date: Oct. 1, 2026

(54) METHOD OF IMAGE PROCESSING FOR A MOTOR VEHICLE

(71) Applicant: Magna Electronics Sweden AB, Vårgårda (SE)

(72) Inventor: Jan-Erik Källhammer, Vårgårda (SE)

(21) Appl. No.: 19/630,938

(22) Filed: Mar. 27, 2026

(30) Foreign Application Priority Data
Mar. 31, 2025 (DE) DE102025112435.3

(51) Int. Cl. G06V 20/56; G01S 7/481; G01S 7/4865; G01S 7/4911; G01S 7/4912; G01S 17/48; G01S 17/931; H04N 23/56

(52) U.S. Cl. CPC G06V 20/56; G01S 7/4815; G01S 7/4865; G01S 7/4911; G01S 7/4912; G01S 17/48; G01S 17/931; H04N 23/56

(57) ABSTRACT

A method comprises capturing images of a region surrounding the motor vehicle via an imaging unit, processing image data, detecting at least one object, and controlling an illumination direction of a light source, which is adapted to illuminate at least part of said region. The method further comprises controlling the illumination direction in order to increase illumination at a distinct region depending on the location of the at least one detected object such that the at least one detected object is illuminated. The method further comprises capturing images of the distinct region via the imaging unit and/or a further imaging unit, and processing image data representing the illuminated object in order to determine object information.

### CROSS REFERENCE TO RELATED APPLICATION

The present application claims the filing benefits of German Patent Application No. DE 102025112435.3, filed Mar. 31, 2025, which is hereby incorporated herein by reference in its entirety.

### TECHNICAL FIELD

This disclosure relates to image processing for a motor vehicle.

### BACKGROUND

Use of imaging sensors in vehicle imaging systems is common and known. Examples of such known systems are described in U.S. Pat. Nos. 5,949,331; 5,670,935 and/or 5,550,677, which are hereby incorporated herein by reference in their entireties.

### SUMMARY

A method for image processing for a motor vehicle includes capturing images of a region surrounding the motor vehicle via an imaging unit, processing image data provided by the imaging unit based on the captured images via a processing unit, detecting at least one object within the processed image data via a detecting unit, and controlling an illumination direction of a light source via a control unit, wherein the light source is adapted to illuminate at least part of said region surrounding the motor vehicle. The method further relates to a data processing apparatus, a device, a driver assistance system, and an automated driving system for a motor vehicle as well as a motor vehicle.

Systems for autonomous/automated driving (AD) and advanced driver assistance system (ADAS) are well known in the prior art. These systems are often based on object detection for determining ranges, distances and/or types of objects like vehicles, pedestrians or obstacles in the scene surrounding the motor vehicle, and in particular in front of the motor vehicle.

In German patent application DE 100 60 734 A1, a motor vehicle is described with means for illuminating traffic signs, wherein these traffic signs are detected via a camera. A headlight is controlled by a control unit in such a way that the signs are illuminated in certain traffic situations.

It is an object of the disclosure to enhance the operation of the vehicle.

The disclosure solves the problem by the features of the independent claims. Further preferred embodiments of the disclosure can be found in the dependent claims and the associated description and drawing.

A method of image processing for a motor vehicle is proposed comprising capturing images of a region surrounding the motor vehicle via an imaging unit, processing image data provided by the imaging unit based on the captured images via a processing unit, detecting at least one object within the processed image data via a detecting unit, and controlling an illumination direction of a light source via a control unit, wherein the light source is adapted to illuminate at least part of said region surrounding the motor vehicle. It is proposed that the illumination direction is controlled in order to increase illumination at a distinct region depending on the location of the at least one detected object such that the at least one detected object is illuminated via the light source. It is further proposed to capture images of the distinct region via the imaging unit and/or a further imaging unit, and to process image data provided by the imaging unit representing the illuminated object in order to determine object information.

The disclosure is based on the finding that the scanning of a scene for the purpose of object detection and classification of said object in the operation of the motor vehicle entails high dynamic loads on the scanning system. More light is generally needed for classification than detection. The solution according to the disclosure solves this problem by particularly illuminating a distinct region based on the location of the detected object. For sufficient object classification, only image data representing the illuminated object needs to be processed. Therefore, fast scanning to cover the whole scene with high update rates is not necessary.

The disclosure is further based on the understanding that in low light situations, the signal-to noise ratio (SNR) limitations of the sensor system together with other limitations, such as fidelity of optics and other components, make the edges of the detected small objects on the road blurry, decreasing the capability of the system to determine the actual size of the object on the road.

At the same time, the level of illumination generated by the low-beam of headlights on a vehicle is limited by regulations to reduce glare for other traffic users.

The disclosure solves these problems by illuminating the distinct region based on the location of the detected object. This improves the signal-to-noise ratio of image data representing the illuminated object. In particular, the boundaries of the object depicted in the image are sharpened. Thereby, object information may be determined with higher precision, allowing better classification of said object.

The method according to the disclosure is preferably used in combination with an object detection system.

The operation of the motor vehicle preferably comprises an automated and/or autonomous operation of the vehicle. Autonomously operated and/or automated vehicles are often referred to as autonomous or self-driving vehicles. This comprises all levels of the classification system of the Society of Automotive Engineers.

The term “light” is understood by the skilled person to comprise all types of electromagnetic waves, including electromagnetic waves outside of the visible spectrum. In the context of the present disclosure, the term “electromagnetic waves” refers specifically to infrared light, and in particular to Near-Infrared (NIR) and Short-Wave Infrared (SWIR) wavelengths. For example, the electromagnetic waves may comprise wavelengths in a range of approximately 800 nm to 900 nm for NIR, and in a range of approximately 1000 nm to 2000 nm for SWIR. Wavelengths having substantial object-penetrating ability, such as those in the very long wavelength infrared (VLWIR) or terahertz (THz) ranges, are generally not utilized.

The imaging unit for capturing images of the region surrounding the motor vehicle preferably comprises a camera. The camera may be a camera for capturing visible light and/or an infrared camera.

The region surrounding the motor vehicle is preferably a region located in driving direction in front of the motor vehicle. It includes the space which the motor vehicle will pass when driving in a certain direction, e.g. the space on a road lying ahead of the vehicle. It further includes an adjacent space, e.g. the space beside the road. The imaging unit preferably captures images in its field of view (FoV) which is a part of the region surrounding the motor vehicle.

The processing unit for processing image data preferably comprises a computer having a computer program which can be executed by the computer. The executed computer program processes the data preferably via a neural network.

The detecting unit for detecting the at least one object preferably comprises a computer and a computer program which can be executed by the computer. The executed computer program preferably detects the object via a neural network.

The light source for illuminating the distinct region is preferably a laser light source, further preferably an infrared laser light source. Further preferably, the light source for illuminating the distinct region is part of a LIDAR system (LIDAR: light detection and range).

Directing the light source to the illumination direction is preferably achieved by a MEMS mirror system (MEMS: micro-electromechanical systems). The MEMS mirror system preferably directs the light source based on a control signal received from the control unit. The control unit for controlling the illumination direction of the light source is preferably part of the MEMS mirror system. Directing the light source to the illumination direction is alternatively or additionally enabled by at least one voice coil, galvanometer scanner and/or spinning polygon.

The processing of image data representing the illuminated object in order to determine object information is preferably performed by a processing unit. This processing unit can be the processing unit mentioned above and/or a further processing unit.

The imaging unit for capturing the distinct region may comprise a LIDAR system, a stereo camera, an infrared camera, a frequency modulated electromagnetic wave source, and/or a mono camera. The imaging unit may preferably comprise a foveated imaging unit. The term “foveated imaging” is understood by the skilled person as a digital image processing technique in which the image resolution, or amount of detail, varies across the image. Preferably, the distinct region indicates the highest resolution region of the image, or the highest detail of image processing of the captured image. The latter can be achieved by higher image SNR, enabled by higher illumination in the region. Such techniques are named in analogy to the center of the eye's retina, the fovea.

In a preferred embodiment of the method according to the disclosure, illuminating the distinct region comprises pulse-wise illuminating the distinct region via the light source, wherein pulsed illuminating light is directed to the distinct region during the pulse-wise illumination. The method further comprises receiving a reflected part of the pulsed illuminating light via a receiving unit, and determining the distance between the detected object and the motor vehicle based on the reflected part of the pulsed illuminating light by measuring the time-of-flight of the pulsed illuminating light and the reflected part of the pulsed illuminating light.

This embodiment provides for a suitable way of obtaining further object information, namely the distance between the object and the motor vehicle.

Preferably, the light source and/or the receiving unit are part of a LIDAR system.

In a further preferred embodiment of the method according to the disclosure, illuminating the distinct region comprises sending a frequency modulated continuous electromagnetic wave via a frequency modulated electromagnetic wave source. The method further comprises receiving a reflected part of the frequency modulated continuous electromagnetic wave via a receiving unit, and determining a distance between the detected object and the motor vehicle based on the reflected part of the frequency modulated continuous electromagnetic wave.

Thereby, frequency modulated continuous wave (FMCW) techniques can be used both for providing directed illumination at the object and simultaneously assessing the distance between the detected object and the motor vehicle.

The distance between the detected object and the motor vehicle is preferably determined based on the sent frequency modulated continuous electromagnetc wave and the reflected part of the frequency modulated continuous electromagnetic wave.

Preferably, the receiving unit is a light receiving unit. Preferably, the light source and/or the receiving unit are part of a FMCW light system.

In a further preferred development of the method according to the disclosure, processing image data representing the illuminated object comprises measuring a dimension of the detected and illuminated object.

Thereby, information particularly relevant for the safe operation of the vehicle is obtained since the dimension may be relevant for determining whether the object is a passable object that may be driven over without causing an unreasonable risk to the vehicle occupants or other road users as specified in UN ECE R157.

The dimension of the detected object may also be referred to as the size, in particular the height of the detected object. Accurate height assessment of the detected object benefits from the focused illumination of the distinct region in question.

In an advantageous embodiment of the method according to the disclosure, the light source comprises at least two light sources. The controlling comprises controlling the illumination direction of each of the at least two light sources such that each light source illuminates the distinct region.

Thereby, the illumination of the distinct region may be divided into or distributed to several less powerful light sources when a scene with a certain field of view (FoV) shall be illuminated. This is of great advantage since the intensity of each light source may be selected to be lower than in an arrangement where one single light source is used for illuminating the distinct region. In other words, a sufficient illumination is achieved by two or more light sources of lower intensity compared to the intensity of a single light source for the same amount of illumination.

According to a further development of the method according to the disclosure, each of the at least two light sources comprise an eye safe infrared laser light source.

Thereby, sufficient illumination can be achieved where at the same time an exposure to the eye can be limited. For example, in cases where the object detected is a human, strict limitations of the maximum permissible exposure (MPE) to the eye of that human must be met. The use of more than one infrared laser light source distributes the exposure to several sources.

Moreover, the development is advantageous since the use of infrared light provides illumination outside of the visible spectrum and glare limitations do not have to be considered.

Preferably, each of the at least two light sources is a class 1 laser of the classification system as specified by the IEC 60825-1. Additionally or alternatively, each of the at least two light sources is an eye safe light emitting diode (LED) as specified by IEC 62471.

In a further preferred embodiment of the method according to the present disclosure, each of the at least two light sources comprise a light element of a matrix headlight of the motor vehicle.

Thereby, a compact solution is provided, where the light sources are integrated into the headlight assembly of the motor vehicle. The control of the illumination direction is achieved by selecting at least one of the light elements of the matrix headlight providing a corresponding pre-set illumination direction.

Preferably, a first one of the two light sources is an LED element of the matrix headlight and a second one of the two light sources is another LED element of the matrix headlight. Further preferably, the first light source is an LED element of the left headlight, and the second light source is an LED element of the right headlight.

According to a further preferred embodiment of the method according to the present disclosure, at least part of the region surrounding the motor vehicle is illuminated via a headlight of the motor vehicle and the distinct region is illuminated via the light source, wherein the light source is a light source separated from the headlight.

This embodiment is based on the finding that the level of illumination generated by the low-beam of headlights on a vehicle is limited by regulations to reduce glare for other traffic users. Accordingly, it is advantageous to use a separated light source for illuminating the distinct region, thereby increasing the SNR at this location.

In a further preferred embodiment of the method according to the present disclosure, illuminating the distinct region comprises pulse-wise illuminating the distinct region via a headlight of the motor vehicle.

This allows for increasing the illumination at the distinct region while at the same time regulations to reduce glare for other traffic users may be fulfilled.

Preferably, the pulse-wise illumination is performed only by selected LED elements of the matrix headlight described above.

According to a further preferred embodiment of the method according to the disclosure, the image data representing the illuminated object is provided by an imaging unit capturing the distinct region, wherein the imaging unit directs a field of view (FoV) to the distinct region.

This further enhances the processing of object information since image data may be provided with higher accuracy via a directed view of the imaging unit.

Moreover, this embodiment provides further advantages due to the directed illumination of the distinct region: It has been mentioned above that fast scanning to cover the whole scene with high update rates is not necessary due to the solution according to the present disclosure. This leads to a lower dynamic load of the scanning system. In turn, the decreased dynamics load leads to decreased sensitivity to inertia (of the scanning system). The decreased sensitivity allows for larger mirrors in a MEMS mirror system. Such a larger mirror may also reach a larger receiving aperture, which improves the light collection ability.

According to a further preferred enhancement, the field of view of the imaging unit and the illumination direction of the light source are controlled via a common mirror arrangement. Thereby, the imaging unit is co-located with the light source, preferably in a monostatic design where the light emitting source and the receiving aperture may be combined in a single scanning mirror.

According to a further preferred embodiment, the imaging unit preferably comprises a MEMS mirror system (MEMS: micro-electromechanical systems) for directing the view of the imaging unit. The imaging unit preferably comprises a sensor array for capturing light received from the MEMS mirror system. An exemplary embodiment of the imaging unit is described in “FoveaCam: A MEMS Mirror-Enabled Foveating Camera” by Brevin Tilmon, Eakta Jain, Silvia Ferrari, Sanjeev Koppal, published in 2020 IEEE International Conference on Computational Photography (ICCP), St. Louis, MO, USA, 2020, pp. 1-11. The authors refer to the described design as a foveating camera design. This camera design distributes resolution onto regions of interest by imaging reflections off a scanning micro-electro mechanical system (MEMS) mirror. A MEMS swiveling mirror is used to direct the foveating camera viewpoint.

In order to solve the problem above, a data processing apparatus for a motor vehicle is proposed comprising a processing unit adapted to process image data provided by an imaging unit based on images, wherein the images are images of a region surrounding the motor vehicle captured via the imaging unit. The data processing apparatus further comprises a detecting unit adapted to detect at least one object within the processed image data. The data processing apparatus further comprises an output unit adapted to output control data for controlling an illumination direction of a light source, wherein the light source is adapted to illuminate at least part of said region surrounding the motor vehicle. The control data is provided for controlling the illumination direction in order to increase illumination at a distinct region depending on the location of the at least one detected object such that the at least one detected object is illuminated via the light source, and the processing unit and/or a further processing unit is adapted to process image data representing the illuminated object in order to determine object information.

In order to solve the problem above, a device for a motor vehicle is proposed. The device comprises an imaging unit adapted to capture images of a region surrounding the motor vehicle. The device further comprises a processing unit adapted to process image data provided by the imaging unit based on the captured images. The device further comprises a detecting unit adapted to detect at least one object within the processed image data. The device further comprises a control unit adapted to control an illumination direction of a light source, wherein the light source is adapted to illuminate at least part of said region surrounding the motor vehicle. The control unit is adapted to control the illumination direction in order to increase illumination at a distinct region depending on the location of the at least one detected object such that the at least one detected object is illuminated via the light source.

The processing unit and/or a further processing unit is adapted to process image data representing the illuminated object in order to determine object information.

In order to solve the problem above, a driver assistance system for a motor vehicle is proposed, comprising a device described above.

The driver assistance system preferably comprises an advanced driver assistance system (ADAS). The skilled person understands this term as a group of functions to support the driver with a safe operation of the motor vehicle. The driver is fully in charge of the safe operation and the system interacts with the driver through a human-machine interface. ADAS uses imaging units such as cameras and frequency modulated continuous electromagnetic wave sources coupled with the processing unit to detect nearby obstacles or driver errors. ADAS consists of collision avoidance technologies such as lane departure warning and various levels of lane keeping, adaptive cruise control, blind-spot applications and driver aids, such as night vision and driver alertness.

In order to solve the problem above, an automated driving system for a motor vehicle is proposed, comprising a device described above.

The skilled person understands the term automated driving system (ADS) as a system for operating a vehicle without a human driver in various levels of operational design domain (ODD).

In order to solve the problem above, a motor vehicle is proposed, comprising a driver assistance system described above and/or comprising an automated driving system described above.

For advantages, embodiments, and design details of the data processing apparatus, device, driver assistance system, and automated driving system for a motor vehicle as well as the motor vehicle, reference may be made to the above description of the corresponding method features of the method of image processing for a motor vehicle according to the disclosure.

### DESCRIPTION OF THE DRAWINGS

In the following the disclosure shall be illustrated on the basis of preferred embodiments with reference to the accompanying drawings, wherein:

FIG. 1 shows a schematic top view of a first embodiment of a motor vehicle;

FIG. 2 shows a schematic design of a first embodiment of a device;

FIG. 3 shows a flow diagram representing a first embodiment of a method of operating a motor vehicle;

FIG. 4 shows a schematic design of a second embodiment of a device;

FIG. 5 shows a schematic design of a third embodiment of a device; and

FIG. 6 shows a schematic design of a fourth embodiment of a device.

### DETAILED DESCRIPTION

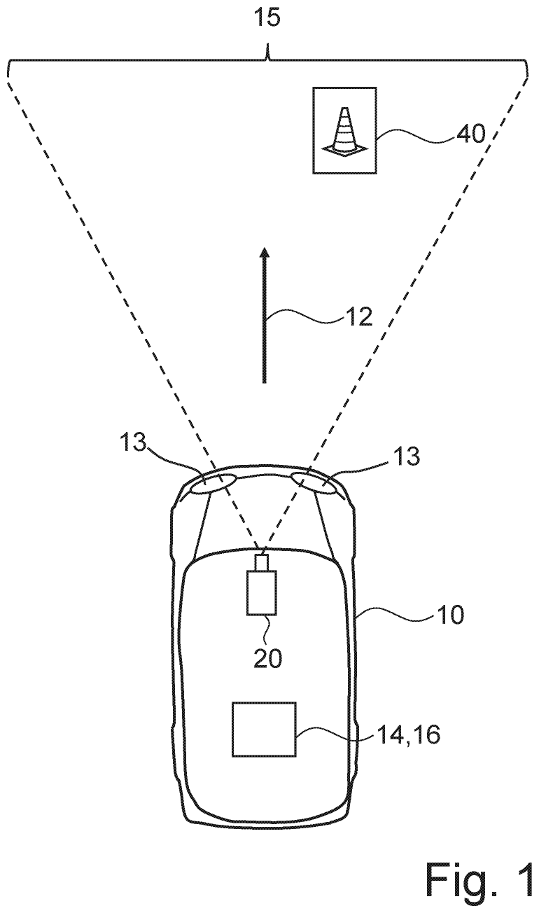

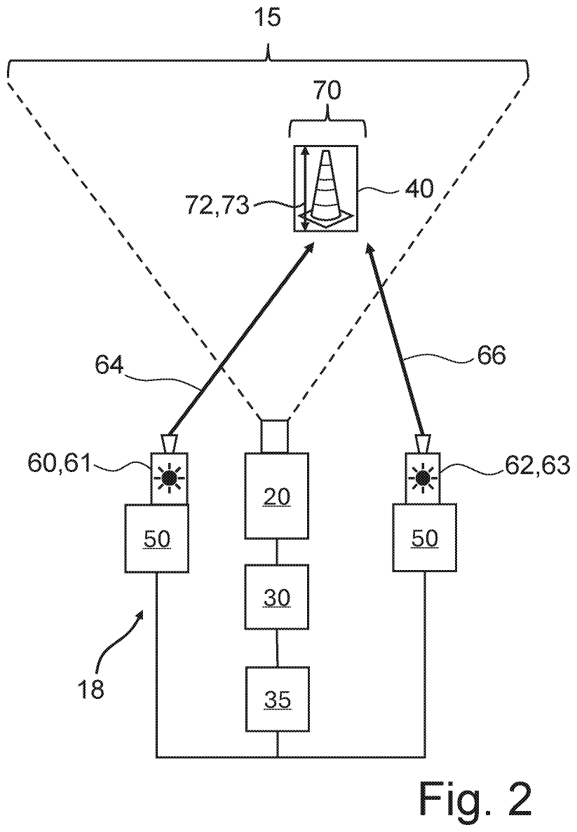

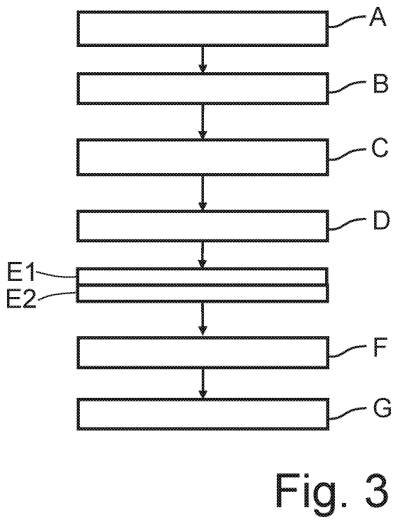

FIG. 1 shows a schematic top view of a motor vehicle 10 driving in driving direction 12. Motor vehicle 10 includes a driver assistance system 14 and an automated driving system 16, each of which can be used for a desired mode of operating the motor vehicle 10. FIG. 2 shows a schematic design of a device 18 for operating the motor vehicle 10 shown in FIG. 1. FIG. 3 shows a schematic flow diagram representing steps of a method of operating the motor vehicle 10 shown in FIG. 1.

In the situation shown in FIG. 1, motor vehicle 10 is operated in a driving mode in which the motor vehicle 10 drives in a driving direction 12 according to a first method step A. In the driving mode shown, the headlights 13 may be switched on in order to illuminate a scene lying in the driving direction 12 in front of the motor vehicle 10.

While driving, images of a region 15 surrounding the motor vehicle 10 are captured via an imaging unit 20 according to a method step B. The imaging unit 20 is a camera. The imaging unit 20 creates image data representing the captured images. Region 15 comprises a scene which lies in driving direction 12 in front of the motor vehicle 10. An object 40 is present within region 15. In particular, the object 40 lies within a field of view (FoV) of the imaging unit 20. The object 40 is a pylon that may collide with the motor vehicle 10 if the motor vehicle 10 keeps the current direction and velocity of its movement.

According to a method step C, a processing unit 30 processes the image data. The processing unit 30 includes a computer having a computer program which can be executed by the computer. The executed computer program processes the data preferably with the help of a neural network.

According to a method step D, a detecting unit 35 detects the object 40 within the processed image data. The detecting unit 35 for detecting the at least one object 40 preferably comprises a computer and a computer program which can be executed by the computer. The executed computer program preferably detects object 40 with the help of a neural network.

The motor vehicle 10 includes a light source 60 and a light source 62 being physically separated from the headlights 13. Light source 60 and light source 62 are each adapted to illuminate part of region 15 surrounding the motor vehicle 10. The light source 60 is an infrared laser light source 61 and the light source 62 is an infrared laser light source 63. An example of an infrared laser light source 61 and 63, respectively, is infrared light emitting diode (IR LED).

According to a method step E1, an illumination direction 64 of light source 60 is controlled via a control unit 50 in order to illuminate a distinct region 70 at the location of the detected object 40. According to a method step E2, an illumination direction 66 of light source 62 is controlled via control unit 50 in order to illuminate distinct region 70 at the location of the detected object 40. The control unit 50 is part of a MEMS system having a mirror arrangement for directing the illumination light into the illumination direction 64 and 66, respectively. Additionally or alternatively, the control unit 50 is part of a voice coil controlled mirror arrangement.

By illuminating the distinct region 70, the signal-to-noise ratio (SNR) of a captured image representing the object 40 is increased. In particular, the boundaries of object 40 depicted in the image are sharpened.

According to a further method step F, images of the distinct region 70 in which the illuminated object 40 is present are captured via imaging unit 20. The imaging unit 20 produces image data representing the detected object 40. An exemplary imaging unit 20 is adapted to direct a field of view to the distinct region 70. I.e. the imaging unit 20 includes a micro-electromechanical system (MEMS) via which the field of view of the imaging unit 20 may be directed into a desired direction.

According to a further method step G, image data representing the illuminated object 40 is processed in order to determine object information 72.

The processing according to method step G is performed by processing unit 30. The processing of the image data representing the illuminated object 40 is performed in order to determine object information 72. The processing comprises measuring a dimension 73 of the detected and illuminated object 40, in particular a height of the object 40.

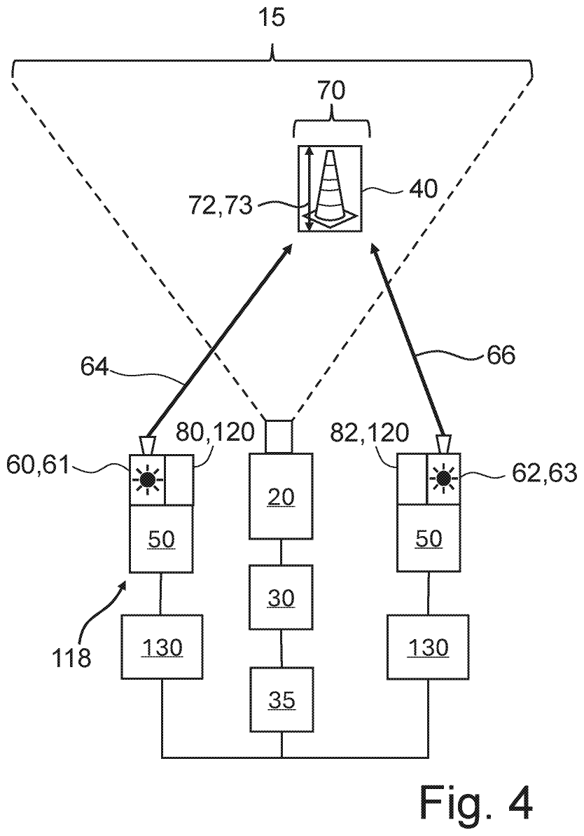

FIG. 4 shows a schematic design of a device 118 for operating the motor vehicle according to the second embodiment. The device 118 is similar to device 18 shown in FIG. 2. Equal elements and elements with the same function are referenced by the same reference numerals as in FIGS. 1 and 2.

Device 118 comprises an imaging unit 20 capturing images of the region 15 surrounding the motor vehicle 10 shown in FIG. 1. Processing unit 30 processes image data provided by the imaging unit 20 based on the captured images. Detection unit 35 detects object 40 within the processed image data. Control unit 50 controls the illumination direction 64 and 66 of light source 60 and 62, respectively, in order to illuminate the distinct region 70 depending on the location of the object 40. The light source 60 and 62 is an infrared laser light source 61 and 63, respectively.

The illumination of the distinct region according to the second embodiment is a pulse-wise illumination, where pulsed illuminating light is emitted by the infrared laser light source 61 and 63, respectively. Device 118 further includes a receiving unit 80 and 82, respectively, that receives a reflected part of the pulsed illuminating light. This includes a reflected part that has been reflected by object 40.

Based on the reflected part of the pulsed illuminating light, a distance between the object 40 and the motor vehicle 10 is determined. The distance is calculated by measuring the time-of-flight of the pulsed illuminating light and the reflected part of the pulsed illuminating light. I.e. the time-of-flight of the pulsed illuminating light traveling the distance from the light source 60, 62 to the object 40 and the reflected part traveling the distance from the object 40 to the receiving unit 80, 82 is measured. The infrared laser light source 61 and 63, respectively, as well as the receiving unit 80 and 82, respectively, are part of a LIDAR system (LIDAR: light detection and range).

The receiving unit 80, 82 provides image data representing an image captured by the receiving unit 80, 82. The receiving unit serves as a further imaging unit 120 for capturing images of the distinct region 70. The image data is processed by a processing unit 130 in order to determine object information 72. The processing comprises measuring a dimension 73 of the detected and illuminated object 40, in particular a height of the object 40.

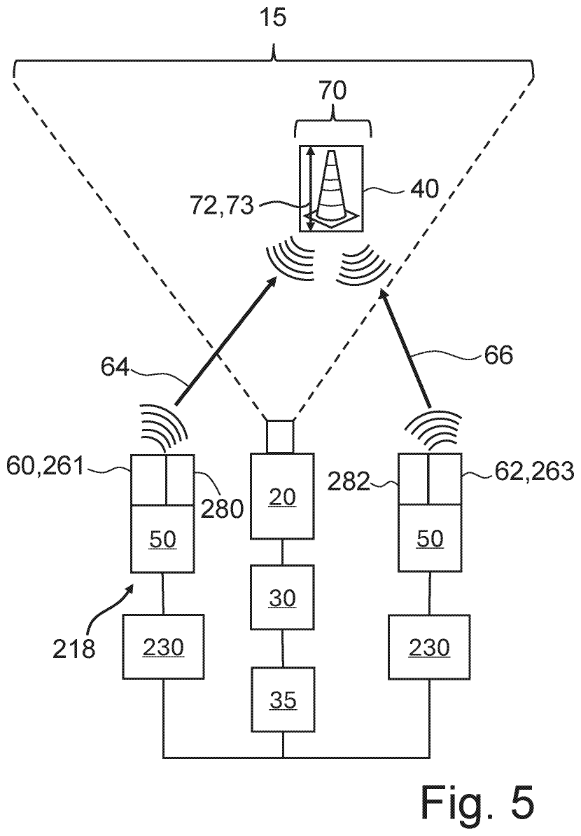

FIG. 5 shows a schematic design of a device 218 for operating the motor vehicle according to the third embodiment. The device 218 is similar to device 118 shown in FIG. 4. Equal elements and elements with the same function are referenced by the same reference numerals as in FIGS. 1 and 4.

Device 218 comprises an imaging unit 20 capturing images of the region 15 surrounding the motor vehicle 10 shown in FIG. 1. Processing unit 30 processes image data provided by the imaging unit based on the captured images. Detection unit 35 detects object 40 within the processed image data. Control unit 50 controls the illumination direction 64 and 66 of light source 60 and 62, respectively, in order to illuminate the distinct region 70 depending on the location of the object 40. The light source 60 and 62 is a frequency modulated electromagnetic wave source 261 and 263, respectively.

The illumination of the distinct region according to the third embodiment is achieved by sending a frequency modulated continuous electromagnetic wave (FMCW) via the frequency modulated electromagnetic wave source 261 and 263.

Device 218 further includes a receiving unit 280 and 282, respectively, that receives a reflected part of the FMCW light. This includes a reflected part being reflected by object 40. The receiving unit 280 and 282, respectively, is a light receiving unit.

Based on the sent FMCW light and based on the reflected part of the FMCW light, a distance between the object 40 and the motor vehicle 10 is determined. The distance is calculated by FMCW light measurement. The frequency modulated electromagnetic wave source 261 and 263, respectively, as well as the receiving unit 280 and 282, respectively, are part of an FMCW system.

The receiving unit 280, 282 provides image data representing an image captured by the receiving unit 280, 282. The image data is processed by a processing unit 230 in order to determine object information 72. The processing may comprises measuring a dimension 73 of the detected and illuminated object 40, in particular a height of the object 40.

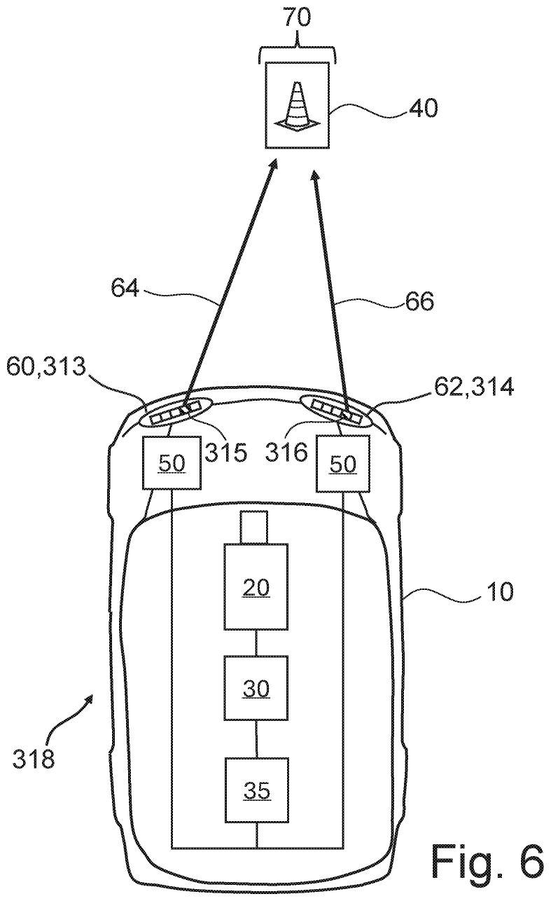

FIG. 6 shows a schematic design of a device 318 for operating the motor vehicle 10 according to the fourth embodiment. The device 318 is similar to device 18 shown in FIG. 2. Equal elements and elements with the same function are referenced by the same reference numerals as in FIGS. 1 and 2. The motor vehicle 10 has matrix headlights 313 and 314 which serve as light sources 60 and 62, respectively.

Control unit 50 controls the illumination direction 64 and 66 of light source 60 and 62, respectively, in order to illuminate the distinct region 70 depending on the location of the object 40. The illumination direction 64 is achieved by selecting a light element 315 of the left headlight 313 for increased illumination. The light element 315 has a fixed illumination direction that corresponds to the desired illumination direction 64 (where other light elements have different illumination directions). The illumination direction 66 is achieved by selecting a light element 316 of the right headlight 314 for increased illumination. The light element 316 has a fixed illumination direction that corresponds to the desired illumination direction 66. The light elements 315 and 316 are LED elements. Illuminating the distinct region 70 via the light element 315 and 316 is a pulse-wise illumination, for example.

Although the disclosure has been illustrated and described in detail in the foregoing embodiments, it is to be understood that the disclosure is not limited to the particular embodiments disclosed, but that other variations can be made by one skilled in the art without departing from the spirit and scope of the disclosure.

### REFERENCE LIST

10 motor vehicle
12 driving direction
13 headlights
14 driver assistance system
15 region
16 automated driving system
18, 118, 218, 318 device
20, 120 imaging unit
30, 130, 230 processing unit
35 detecting unit
50 control unit
60,62 light source
61,63 infrared laser light source
64,66 illumination direction
70 distinct region
72 object information
73 dimension
80, 82 receiving unit
261, 263 frequency modulated electromagnetic wave source
280, 282 receiving unit
313, 314 headlight
315, 316 light element
A, B, C, D, E1, E2, F, G method step

1. A method of image processing for a motor vehicle, comprising:
capturing images of a region surrounding the motor vehicle via an imaging unit,
processing image data provided by the imaging unit based on the captured images via a processing unit,
detecting at least one object within the processed image data via a detecting unit, and
controlling an illumination direction of a light source via a control unit, wherein the light source is adapted to illuminate at least part of said region surrounding the motor vehicle,
controlling the illumination direction in order to increase illumination at a distinct region depending on a location of the at least one detected object such that the at least one detected object is illuminated via the light source,
capturing images of the distinct region via the imaging unit and/or a further imaging unit, and
processing image data provided by the imaging unit representing the illuminated object in order to determine object information.

2. The method according to claim 1, wherein:
illuminating the distinct region comprises pulse-wise illuminating the distinct region via the light source, wherein pulsed illuminating light is directed to the distinct region during the pulse-wise illumination; and
the method further comprises:
receiving a reflected part of the pulsed illuminating light via a receiving unit, and
determining a distance between the detected object and the motor vehicle based on the reflected part of illuminating light by measuring a time-of-flight of the pulsed illuminating light and the reflected part of the pulsed illuminating light.

3. The method according to claim 1, wherein:
illuminating the distinct region comprises sending a frequency modulated continuous electromagnetic wave via a frequency modulated electromagnetic wave source, and
the method further comprises:
receiving a reflected part of the frequency modulated continuous electromagnetic wave via a receiving unit, and
determining a distance between the detected object and the motor vehicle based on the sent frequency modulated continuous wave and the reflected part of the frequency modulated continuous electromagnetic wave.

4. The method according to claim 1, wherein processing image data representing the illuminated object comprises measuring a dimension of the detected and illuminated object.

5. The method according to claim 1, wherein:
the light source comprises at least two light sources, and
the controlling comprises controlling the illumination direction of each of the at least two light sources such that each light source illuminates the distinct region.

6. The method according to claim 5, wherein each of the at least two light sources comprise an eye safe infrared laser light source.

7. The method according to claim 5, wherein each of the at least two light sources comprise a light element of a matrix headlight of the motor vehicle.

8. The method according to claim 1, wherein:
illuminating at least part of the region surrounding the motor vehicle via a headlight of the motor vehicle, and
illuminating the distinct region via the light source, wherein the light source is a light source separated from the headlight.

9. The method according to claim 1, wherein illuminating the distinct region comprises pulse-wise illuminating the distinct region via a headlight of the motor vehicle.

10. The method according to claim 1, wherein the image data representing the illuminated object is provided by an imaging unit capturing the distinct region, wherein the imaging unit directs a field of view to the distinct region.

11. The method according to claim 10, wherein the field of view of the imaging unit and the illumination direction of the light source are controlled via a common mirror arrangement.

12. The method according to claim 10, wherein the imaging unit comprises a micro-electromechanical system (MEMS) for directing the view of the imaging unit.

13. A data processing apparatus for a motor vehicle, comprising:
a processing unit adapted to process image data provided by an imaging unit based on images, wherein the images are images of a region surrounding the motor vehicle captured via the imaging unit;
a detecting unit adapted to detect at least one object within the processed image data;
an output unit adapted to output control data for controlling an illumination direction of a light source, wherein the light source is adapted to illuminate at least part of said region surrounding the motor vehicle;
wherein the control data is provided for controlling the illumination direction in order to increase illumination at a distinct region depending on a location of the at least one detected object such that the at least one detected object is illuminated via the light source; and
wherein the processing unit and/or a further processing unit is adapted to process image data representing the illuminated object in order to determine object information.

14. A device for a motor vehicle, comprising:
an imaging unit adapted to capture images of a region surrounding the motor vehicle;
a processing unit adapted to process image data provided by the imaging unit based on the captured images;
a detecting unit adapted to detect at least one object within the processed image data;
a control unit adapted to control an illumination direction of a light source, wherein the light source is adapted to illuminate at least part of said region surrounding the motor vehicle;
wherein the control unit is adapted to control the illumination direction in order to increase illumination at a distinct region depending on a location of the at least one detected object such that the at least one detected object is illuminated via the light source; and
wherein the processing unit and/or a further processing unit is adapted to process image data representing the illuminated object in order to determine object information.

15. The device of claim 14, wherein the device is part of a driver assistance system.

16. The device of claim 14, wherein the device is part of an automated driving system.
